(19) United States
(12) Patent Application Publication
(10) Pub. No.: US 2014/0136702 A1
(43) Pub. Date: May 15, 2014

(54) METHOD AND APPARATUSES FOR SHARING DATA IN A DATA SHARING SYSTEM

(71) Applicant: Samsung Electronics Co., Ltd., Gyeonggi-do (KR)

(72) Inventors: Mu-Sik Kwon, Seoul (KR); Sun-Tae Jung, Gyeonggi-do (KR); Seong-Taek Hwang, Gyeonggi-do (KR)

(73) Assignee: Samsung Electronics Co., Ltd., Gyeonggi-do (KR)

(21) Appl. No.: 14/076,878

(22) Filed: Nov. 11, 2013

(30) Foreign Application Priority Data
Nov. 9, 2012 (KR) 10-2012-0126957

(51) Int. Cl. H04L 29/06

(52) U.S. Cl. CPC H04L 63/0861
USPC 709/225

(57) ABSTRACT

A method and apparatuses are provided for sharing data in a data sharing system. The method includes receiving, by a first terminal, a user input for transmitting previously-stored user characteristic data to a second terminal; discovering the second terminal to which the previously-stored user characteristic data is to be transmitted; and transmitting the previously-stored user characteristic data to the second terminal.

### PRIORITY

This application claims priority under 35 U.S.C. §119(a) to Korean Patent Application Serial No. 10-2012-0126957, which was filed in the Korean Intellectual Property Office on Nov. 9, 2012, the entire content of which is hereby incorporated by reference.

### BACKGROUND OF THE INVENTION

1. Field of the Invention

The present invention relates generally to a method for recognizing a user, and more particularly, to a method and apparatuses for sharing data in a data sharing system, wherein the apparatuses share user characteristic data, which is individually stored in the apparatuses in order to recognize a user.

2. Description of the Related Art

When a user intends to replace a portable terminal, i.e., a old terminal, with a new terminal, it is common for the user to move various personal content, such as a telephone directory, from the old terminal to the new terminal, for example, so that the user can use the new terminal without having to re-input the telephone numbers to the new terminal.

Additionally, it is now possible to release a lock screen of a portable terminal through facial recognition. Specifically, a user's face is registered in the portable terminal. Further, whenever the user releases the lock screen of the portable terminal using the user's face, the portable terminal receives the user's face data as input in this process. However, when the user then replaces an old portable terminal, in which the registered face data is stored, with a new portable terminal that also uses facial recognition, the user must re-register his/her own face as the face data to the new portable terminal.

### SUMMARY OF THE INVENTION

Accordingly, the present invention is designed to address at least the problems and/or disadvantages described above and to provide at least the advantages described below.

An aspect of the present invention is to provide a method and apparatuses for sharing data in a data sharing system, wherein the apparatuses share user characteristic data, which is individually stored in the apparatuses in order to recognize a user.

In accordance with an aspect of the present invention, a method for sharing data by a first terminal is provided. The method includes receiving a user input for transmitting user characteristic data to a second terminal; discovering the second terminal to which the user characteristic data is to be transmitted; and transmitting the user characteristic data to the second terminal.

In accordance with another aspect of the present invention, a method for sharing data by a device is provided. The method includes receiving input data for authenticating a user, from the user; comparing the input data with recognition data; determining a similarity between the input data and the recognition data; determining whether the similarity is greater than or equal to a first reference value; and determining that the user is successfully authenticated, when the similarity is greater than or equal to the first reference value.

In accordance with another aspect of the present invention, a mobile communication terminal is provided. The mobile communication terminal includes a user input unit configured to receive a user input for transmitting user characteristic data to another terminal; and a communication interface configured to: discover the another terminal to which the user characteristic data is to be transmitted, and transmit the user characteristic data to the another terminal.

In accordance with another aspect of the present invention, a device is provided. The device includes a user input unit: configured to receive input data for authenticating a user from the user; and a controller configured to: compare the input data with recognition data included in user characteristic data, determine a similarity between the input data and the recognition data, determine whether the similarity is greater than or equal to a first reference value, and determine that the user is successfully authenticated, when the similarity is greater than or equal to the first reference value.

### BRIEF DESCRIPTION OF THE DRAWINGS

The above and other features, aspects, and advantages of the present invention will be more apparent from the following detailed description taken in conjunction with the accompanying drawings, in which:

FIG. 1 illustrates a data sharing system according to an embodiment of the present invention;

FIG. 2 illustrates a mobile communication terminal and a device in a data sharing system according to an embodiment of the present invention;

FIG. 3 is a signal flow diagram illustrating a method for sharing data in a data sharing system according to an embodiment of the present invention;

FIG. 4 is a flowchart illustrating a method for recognizing a user by a mobile communication terminal in a data sharing system according to an embodiment of the present invention;

FIG. 5 is a flowchart illustrating another method for recognizing a user by a mobile communication terminal in a data sharing system according to an embodiment of the present invention;

FIG. 6 is a signal flow diagram illustrating a method for sharing data in the data sharing system according to an embodiment of the present invention;

FIG. 7 is a signal flow diagram illustrating a method for sharing data in the data sharing system according to an embodiment of the present invention; and

FIG. 8 is a signal flow diagram illustrating a method for sharing data in the data sharing system according to an embodiment of the present invention.

### DETAILED DESCRIPTION OF EMBODIMENTS OF THE PRESENT INVENTION

Hereinafter, various embodiments of the present invention will be described in detail with reference to the accompanying drawings. The following description includes specific details such as elements, etc., and the specific details are only provided in order to help a more comprehensive understanding of the present invention. Therefore, it will be apparent to those skilled in the art that predetermined changes and modifications may be made in the specific details without departing from the scope of the present invention.

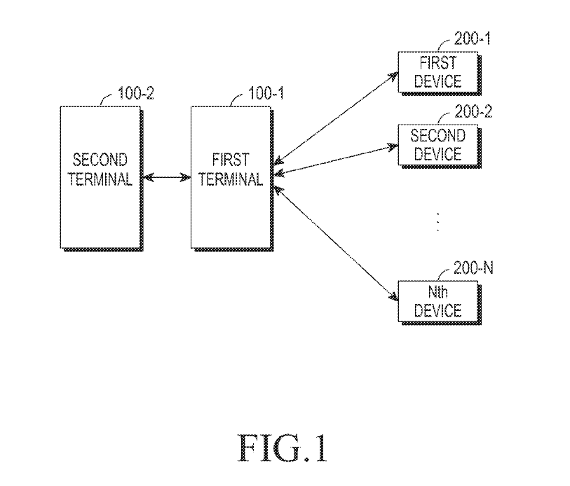

FIG. 1 illustrates a data sharing system according to an embodiment of the present invention.

Referring to FIG. 1, the data sharing system includes a first terminal 100-1, a second terminal 100-2, a first device 200-1, a second device 200-2, . . . , and an N^{th} device 200-N.

In this description, it is assumed that user characteristic data is previously stored in the first terminal 100-1, which may transmit the previously stored user characteristic data to the second terminal 100-2 or the devices 200-1 to 200-N, and thereby may share the previously stored user characteristic data with the second terminal 100-2 or the devices 200-1 to 200-N.

For example, when a user of the first terminal 100-1 replaces the first terminal 100-1 with the second terminal 100-2. The first terminal 100-1 transmits user characteristic data stored therein to the second terminal 100-2, upon receiving a request from the user. The first terminal 100-1 may also perform a discovery function, and may transmit the user characteristic data to another mobile communication terminal or device in a network, to which the first terminal 100-1 belongs.

Herein, the user characteristic data is divided into recognition data and preference data. The recognition data is used to recognize a user of a mobile communication terminal, and may include at least one of a face image, an iris image, a fingerprint image, voice data, handwriting data, signature data of the user, etc. The preference data, for example, may include a telephone directory, an address book, the user's favorite moving image, the user's favorite music, the user's favorite channel, the user's favorite application, etc., and may also include a user interface optimized by the user.

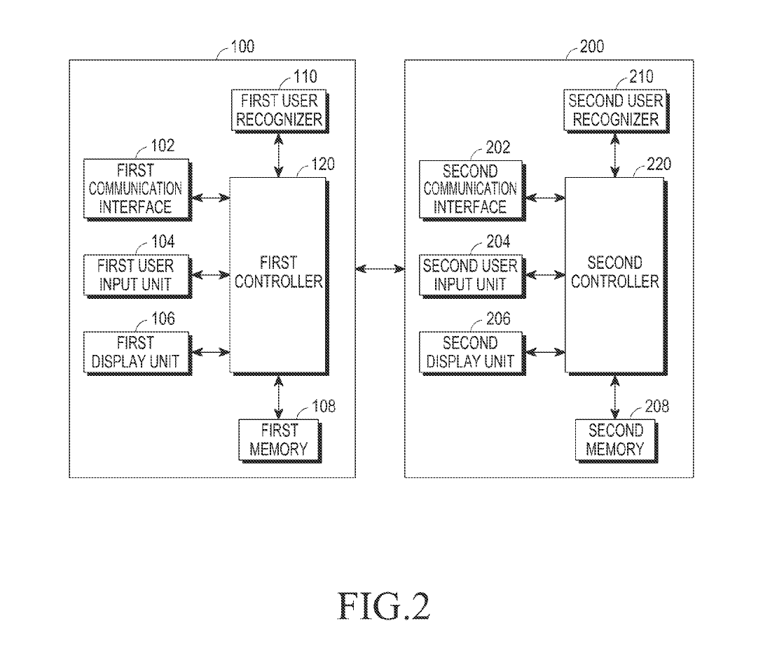

FIG. 2 illustrates a mobile communication terminal and a device in a data sharing system according to an embodiment of the present invention.

Referring to FIG. 2, a mobile communication terminal 100 includes a first communication interface 102, a first user input unit 104, a first display 106, a first memory 108, a first user recognizer 110, and a first controller 120.

The first communication interface 102 performs wired or wireless communication of the mobile communication terminal 100, including transmitting user characteristic data stored in the first memory 108 to another apparatus, such as another mobile communication terminal or the device 200. Also, the first communication interface 102 may receive a request for transmitting the user characteristic data to another mobile communication terminal or the device 200, from the another mobile communication terminal or the device 200.

The first user input unit 104 receives a user input, including a user input for transmitting the user characteristic data to another mobile communication terminal or the device 200. Also, the first user input unit 104 may receive user input for sending a request for user characteristic data to another mobile communication terminal or the device 200.

The first display 106 displays various data stored in the mobile communication terminal 100, including displaying a user interface in such a manner as to change the user interface in form according to the user characteristic data accumulated in the first memory 108, i.e., according to preference data included in the user characteristic data. For example, when a keypad is displayed on a touch screen (not shown), the first display 106 may display a key preferred by the user in a larger size than other keys, or may change an arrangement pattern of keys according to the user preference data.

The first memory 108 stores various data for controlling the mobile communication terminal 100, including the user characteristic data.

According an embodiment of the present invention, the first memory 108 stores a user recognition program for recognizing a user or an application for recognizing a user. The user recognition program or application for recognizing a user use the user characteristic data stored in the first memory 108, particularly, the recognition data.

Under the control of the first controller 120, the first memory 108 separately stores and manages common data for configuring the user recognition program or the application for recognizing a user, and the user characteristic data.

The mobile communication terminal 100 transmits the user characteristic data to another mobile communication terminal or the device 200, on which a program or an application that uses the user characteristic data is installed, so that the another mobile communication terminal or the device 200 can more accurately recognize the user using the user characteristic data.

Further, the another mobile communication terminal or the device 200 that has received the user characteristic data, may construct and display a user interface optimized for the user based on the user characteristic data.

The first user recognizer 110 receives input data for authenticating a user. According to an embodiment of the invention, the first user recognizer 110 may include a camera or a fingerprint scanner, and may receive as input a face image, an iris image, or a fingerprint image of the user, respectively, from the user. Further, the first user recognizer 110 may be implemented with the first user input unit 104, e.g., a touch screen, and may receive a signature from the user as an input.

The first user recognizer 110 compares the face image, the fingerprint image, the iris image or the fingerprint image, which has been received as input from the user, with recognition data, such as a face image, an iris image, a fingerprint image, voice data, handwriting data or signature data, which has already been stored in the first memory 108. Based on a result of the comparison, the first user recognizer 110 determines how similar the input data is to the recognition data, namely, a similarity of the input data.

According to an embodiment of the present invention, the recognition data may be divided into first recognition data and second recognition data, according to a similarity. The first recognition data is recognition data having a similarity that is greater than or equal to a first reference value, and the second recognition data is recognition data having a similarity that is greater than or equal to a second reference value. Herein, it is assumed that the second reference value is greater than the first reference value. Namely, the second recognition data has a higher similarity than the first recognition data.

When the first user recognizer 110 determines similarities of the various input data (face, fingerprint, iris, fingerprint, etc.), which have been received as input from the user, the first controller 120 may determine whether the similarity for each of various input data is greater than or equal to the first reference value or second reference value. The first controller 120 may determine input data, which has a similarity that is greater than or equal to the first reference value among the various input data, as the first recognition data. The first controller 120 also determines first recognition data, which has a similarity greater than or equal to the second reference value among the multiple first recognition data, as the second recognition data. In other words, the first controller 120 determines input data, which has a similarity that is greater than or equal to the second reference value among the various input data, as the second recognition data. The first controller 120 may store the first recognition data, which has been determined as the second recognition data, in the first memory 108.

Alternatively, the recognition data may be divided into first recognition data, second recognition data, third recognition data, . . . , and N^{th} recognition data (N is a natural number), according to a similarity. In this case, it is assumed that a similarity becomes higher as N increases.

The first controller 120 controls the first memory 108 to store first recognition data having a similarity greater than or equal to the first reference value. Alternatively, the first controller 120 may control the first memory 108 to store only second recognition data having a similarity greater than or equal to the second reference value.

Also, the first controller 120 may control the first memory 108 to store any one of third recognition data to N^{th} recognition data, each having a similarity greater than the second reference value.

As described above, the first controller 120 may apply a reference (first reference value) to a similarity for authenticating a user, and may apply another reference (second reference value to N^{th} reference value) to another similarity for updating user characteristic data. By applying the different references to the similarities, the mobile communication terminal 100 may maintain or increase the accuracy of user characteristic data for authenticating a user.

The first controller 120 controls an overall operation of the mobile communication terminal 100 including determining whether a user who has entered input data is successfully authenticated, i.e., whether the user is a user permitted to use the mobile communication terminal 100, based on a similarity of the input data corresponding to a result of comparing the input data with recognition data.

For example, when using fingerprint data, when a similarity between fingerprint data stored in the first memory 108 and fingerprint data, which has been input through the first user recognizer 110, is equal to or greater than 80%, namely, when the input fingerprint data is similar to the stored fingerprint data by 80% or more, the user who has input the fingerprint is determined as an actual user of the mobile communication terminal 100.

Further, when a similarity between the fingerprint recognized by the first user recognizer 110 and the fingerprint data stored in the first memory 108 is at least equal to 85%, the first controller 120 determines that the user who has input the fingerprint is an actual user of the mobile communication terminal 100, and for example, may release the lock of the mobile communication terminal 100, or may control the first display 106 to display a user interface preferred by the user, as an operation according to a result of the recognition. At this time, a similarity (namely, 80%) of fingerprint data for determining whether the user who has input the fingerprint is a user of the mobile communication terminal 100 is a similarity of the recognition data.

For example, when a similarity between the fingerprint input through the first user recognizer 110 and the recognition data (namely, fingerprint data) stored in the first memory 108 is greater than or equal to 80%, the fingerprint is determined as first recognition data, and when the similarity is greater than or equal to 90%, the fingerprint is determined as second recognition data.

Additionally, when the data that has been input through the first user recognizer 110 is the first recognition data, the first controller 120 determines the user, who has input the first recognition data, as an actual user of the mobile communication terminal 100 and controls the first memory 108 to store only the second recognition data.

When the similarity of the fingerprint recognized by the first user recognizer 110 is equal to 85%, the fingerprint corresponds to the first recognition data. Accordingly, the first controller 120 may determine that the first recognition data, namely, the user who has input the fingerprint, is an actual user of the mobile communication terminal 100. However, because the fingerprint does not correspond to the second recognition data, the first controller 120 may control the first memory 108 to not store the fingerprint.

When the similarity of the fingerprint recognized by the first user recognizer 110 is equal to 92%, the fingerprint is the first recognition data, and simultaneously, becomes the second recognition data. In this case, the first controller 120 determines that the user who has input the fingerprint is an actual user of the mobile communication terminal 100, and simultaneously, controls the first memory 108 to store the fingerprint as the second recognition data.

Referring again to FIG. 2, the device 200 includes a second communication interface 202, a second user input 204, a second display 206, a second memory 208, a second user recognizer 210, and a second controller 220. Each of the components operates in the same way as the first communication interface 102, the first user input unit 104, the first display 106, the first memory 108, the first user recognizer 110, and the first controller 120 described above. Accordingly, a repetitive description of the second communication interface 202, the second user input 204, the second display 206, the second memory 208, the second user recognizer 210, and the second controller 220 will be provided herein.

Additionally, when the device 200 subscribes to a home network such as Digital Living Network Alliance (DLNA), the second communication interface 202 may discover the home network, and thereby may identify the mobile communication terminal 100 or other devices, which subscribe to the home network. When apparatuses which subscribe to the home network, for example, the mobile communication terminal 100 and the other devices are identified, the second communication interface 202 may transmit the user characteristic data stored in the second memory 208 to at least one of the apparatuses which subscribe to the home network, under the control of the second controller 220.

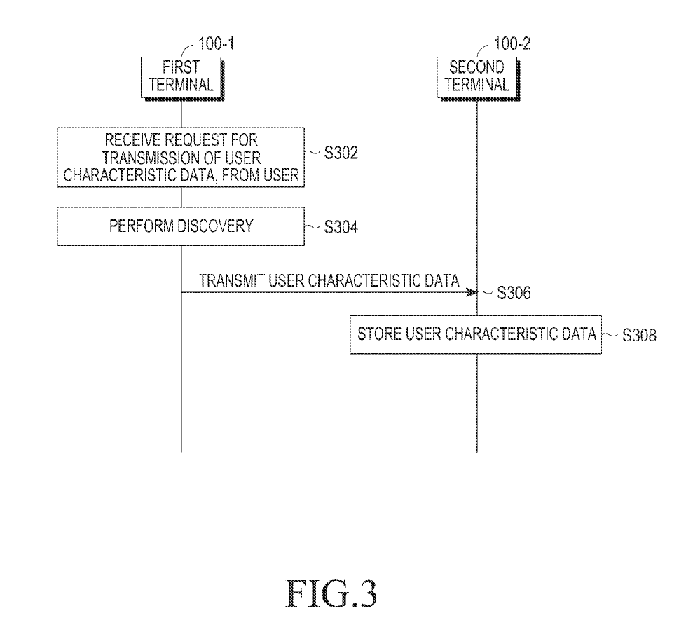

FIG. 3 is a signal flow diagram illustrating a method for sharing data in a data sharing system according to an embodiment of the present invention. In FIG. 3, user characteristic data is previously stored in the first terminal 100-1 and is not already stored in the second terminal 100-2.

Referring to FIG. 3, the first terminal 100-1 receives a request for transmission of user characteristic data, from a user in step S302. For example, the first terminal 100-1 receives a user input that requests the first terminal 100-1 to transmit the user characteristic data stored in the first memory 108 to the second terminal 100-2, from the user, through the first user input unit 104.

In step S304, the first terminal 100-1 performs a discovery process to search for the second terminal 100-2, to which the user characteristic data is to be transmitted. When the second terminal 100-2 is found, the first terminal 100-1 transmits the user characteristic data to the second terminal 100-2 in step S306.

In step S308, the second terminal 100-2 receives and stores the user characteristic data transmitted from the first terminal 100-1.

Alternatively, the first terminal 100-1 may be connected to the second terminal 100-2 by a wire. In this case, when a user requests the first terminal 100-1 to transmit user characteristic data to the second terminal 100-2, the discovery process is not performed, and the first terminal 100-1 may immediately transmit the user characteristic data to the second terminal 100-2.

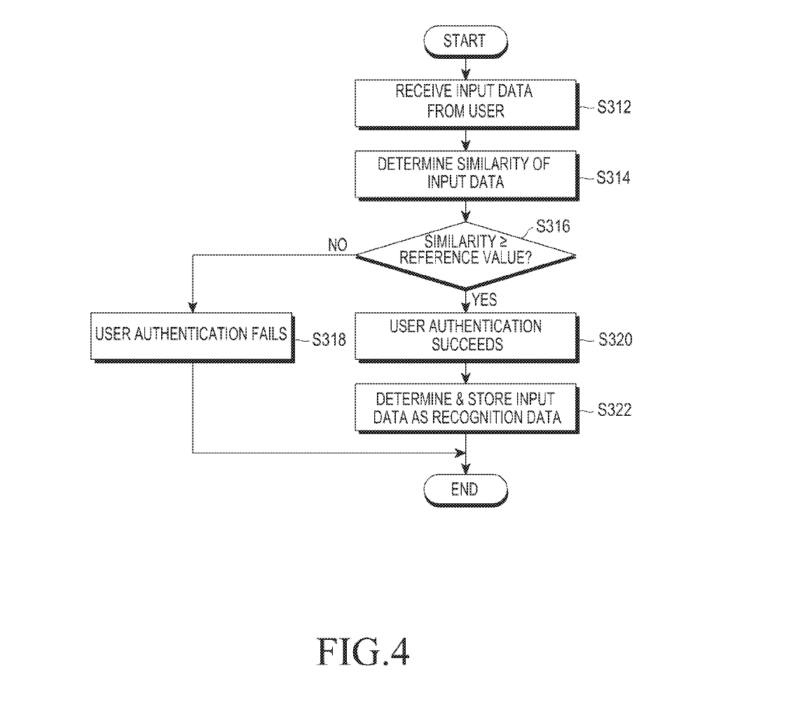

FIG. 4 is a flowchart illustrating a method for recognizing a user by a mobile communication terminal in a data sharing system according to an embodiment of the present invention.

Referring to FIG. 4, the mobile communication terminal 100 receives input data from a user in order to authenticate the user. Specifically, the first user recognizer 110 of the mobile communication terminal 100 receives input data from a user in step S312. For example, the first user recognizer 110 may receive, as input data, a face image, an iris image, fingerprint data, signature data, various handwriting data from the user, etc.

The first user recognizer 110 compares the input data received from the user with recognition data included in user characteristic data stored in the first memory 108. In step S314, the first user recognizer 110 determines a result of comparing the input data with the recognition data, namely, a similarity of the input data.

When the similarity of the input data has been determined, the first controller 120 determines whether the similarity is greater than or equal to a reference value in step S316. the similarity is less than the reference value, i.e., No from step S316, the first controller 120 determines that the user fails to be authenticated in step S318. Because the user has failed to be authenticated, the mobile communication terminal 100 may complete the authentication operation without performing a separate operation.

However, when the similarity is greater than or equal to the reference value, i.e., Yes from step S316, the first controller 120 determines that the user is successfully authenticated in step S320.

In step S322, the first controller 120 stores the input data received through the first user recognizer 110 in step S312, in the first memory 108, as recognition data.

According to an embodiment, the input data may be stored as recognition data included in user characteristic data. The user characteristic data may include multiple recognition data. The user characteristic data may include the recognition data for recognizing or authenticating a user and preference data representing user preferences.

In FIG. 4, the input data, which has been received through the first user recognizer 110 in step S312 may be accumulated in the first memory 108, as data for recognizing or authenticating a user among the user characteristic data.

For example, assuming that the user has input a face image to the mobile communication terminal 100 10 times and authentication was successful 7 of the 10 times, the mobile communication terminal 100 may store all the successful face images, namely, the 7 face images which were successful for authentication, as the recognition data in the user characteristic data.

The first controller 120 may store the 7 face images, namely, the input data that has been successfully authenticated, in the first memory 108, and to update the recognition data stored in the first memory 108.

When inputting a face image, a similarity of which to at least one of the 7 face images is equal to or greater than a reference value, the mobile communication terminal 100 may admit that the relevant face image is the user's face image.

In FIG. 4, although only the mobile communication terminal 100 has been described, the device 200 may also perform a similar method for recognizing a user. Namely, the device 200 compares input data received through the second user recognizer 210 with pre-stored recognition data from the second memory 208, and determines a similarity of the input data. When the similarity is greater than or equal to a reference value, a user is successfully authenticated. When the user is successfully authenticated, the second controller 220 may store the input data received through the second user recognizer 210 in the second memory 208, as recognition data.

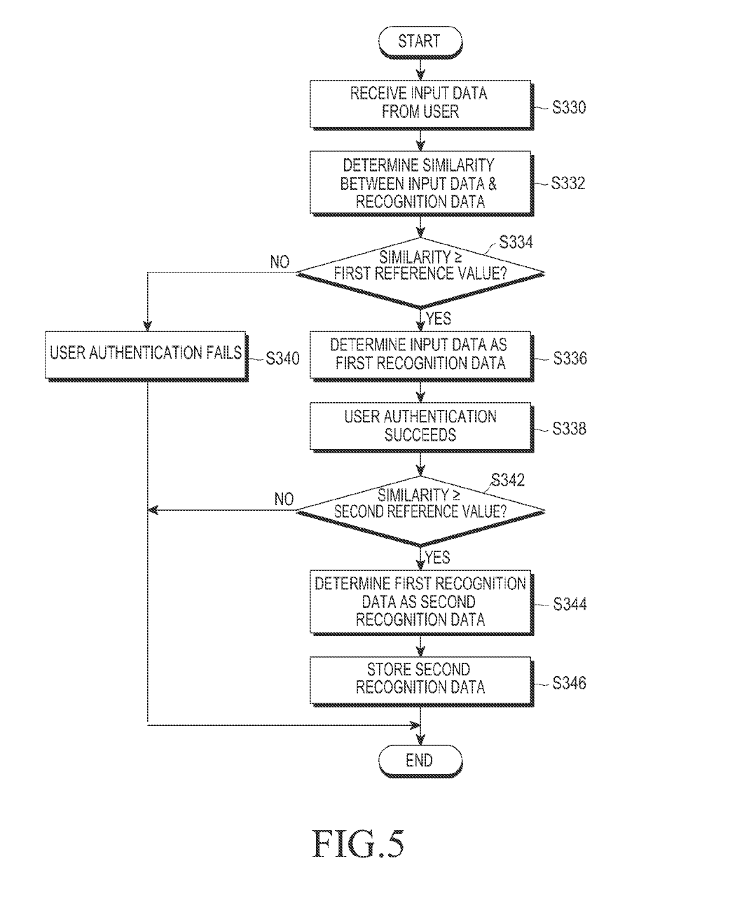

FIG. 5 is a flowchart illustrating another method for recognizing a user by a mobile communication terminal in a data sharing system according to an embodiment of the present invention.

Referring to FIG. 5, the mobile communication terminal 100 receives input data from a user in order to authenticate the user. Specifically, the first user recognizer 110 of the mobile communication terminal 100 receives input data from a user in step S330. For example, the first user recognizer 110 may receive, as input data, a face image, an iris image, fingerprint data, signature data, various handwriting data from the user, etc.

In step S332, the first user recognizer 110 compares the input data received from the user with recognition data included in user characteristic data stored in the first memory 108 and determines a similarity between the input data and the recognition data.

In step S334, the first controller 120 determines whether the similarity is greater than or equal to a first reference value. When the similarity is less than the first reference value, i.e., No from step S334, the first controller 120 determines that the user fails to be authenticated in step S340. Because the user has failed to be authenticated, the mobile communication terminal 100 may complete the authentication operation without performing a separate operation.

However, when the similarity is greater than or equal to the first reference value, i.e., Yes from step S334, the first controller 120 determines that the input data received in step S330 is first recognition data in step S336. In step S338, the first controller 120 determines that the user is successfully authenticated.

In step S342, the first controller 120 determines whether the input data (namely, the first recognition data) has a similarity that is greater than or equal to a second reference value, where the second reference value is greater than the first reference value.

When the first recognition data has a similarity less than the second reference value, i.e., No from step S342, the first controller 120 may end the procedure.

However, when the first recognition data has a similarity that is greater than or equal to the second reference value, i.e., Yes from step S342, the first controller 120 determines that the first recognition data is also second recognition data in step S344. In step S346, the first controller 120 stores the second recognition data in the first memory 108 in step S346.

As described above, based on the similarity of the input data, the first controller 120 of the mobile communication terminal 100 according to the present invention may determine whether the input data is to be stored in the first memory 108 as recognition data.

For example, when the first reference value is equal to 75% and the second reference value is equal to 90%, and the first input data, which has been input through the first user recognizer 110 in step S330, has a similarity of 92%, the first input data may be determined as first recognition data in step S336 and as second recognition data in step S344. Thereafter, the second recognition data may be stored in the first memory 108 in step S346.

When the second input data, which has been input through the first user recognizer 110 in step S330, has a similarity of 85, the second input data may be determined as first recognition data in step S336, and the first controller 120 may determine that that the user is successfully authenticated in step S338. However, because the second input data has a similarity less than the second reference value, it may not be stored in the first memory 108 as second recognition data.

According to another embodiment of the present invention, the first controller 110 may compare the similarity of the input data the second reference value first. The first controller 110 compares the similarity of the input data the second reference value first, and determine whether the similarity is greater than or equal to the second reference value. If the similarity is greater than or equal to the second reference value, the first controller 110 may determine that the user is successfully authenticated and stores the input data as the second recognition data. If the similarity is less than the second reference value, the first controller 110 compares the similarity of the input data the first reference value. If the similarity is greater than or equal to the first reference value, the first controller 110 may determine that the user is successfully authenticated.

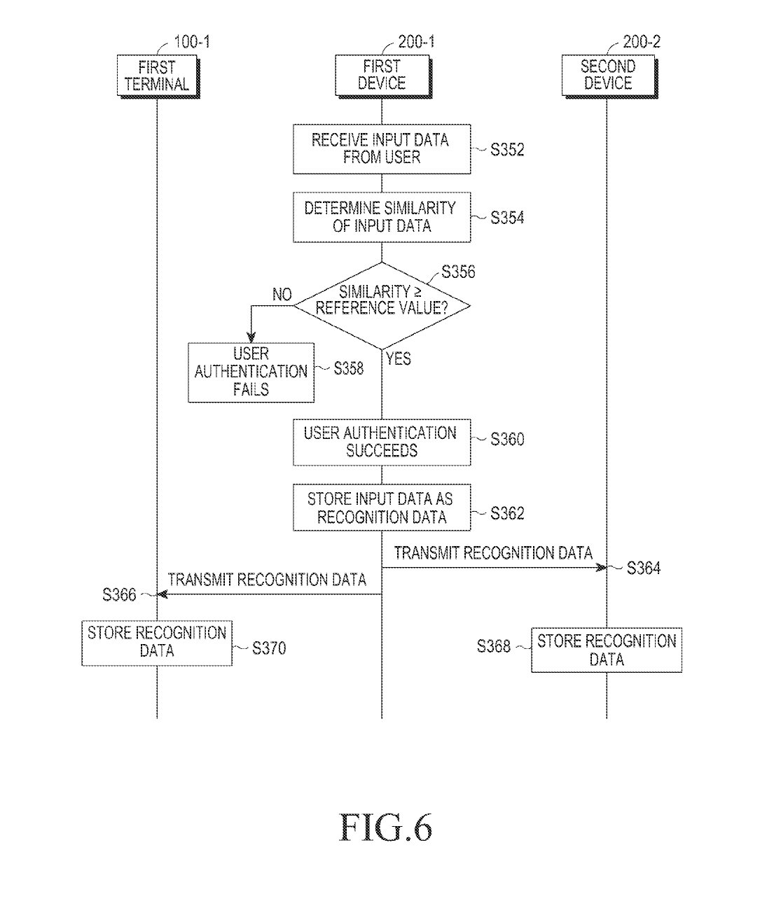

FIG. 6 is a signal flow diagram illustrating a method for sharing data in the data sharing system according to an embodiment of the present invention. In FIG. 6, the first terminal 100-1, the first device 200-1, and the second device 200-2 share identical user characteristic data.

Referring to FIG. 6, the first device 200-1 receives input data for authenticating a user, from the user in step S352. In step S354, the second user recognizer 210 of the first device 200-1 compares the input data received from the user with recognition data included in user characteristic data that is pre-stored in the second memory 208, and in step S354, determines a similarity of the input data.

In step S356, the second controller 220 determines whether the similarity of the input data is greater than or equal to a reference value. Herein, when the input data has a similarity that is greater than or equal to the reference value, the user is successfully authenticated.

When the input data has a similarity that is not greater than or equal to the reference value, the second controller 220 determines that the user fails to be authenticated in step S358.

When the input data has a similarity that is greater than or equal to the reference value, the second controller 220 determines that the user is successfully authenticated in step S360. In step S362, the second controller 220 of the first device 200-1 stores the input data as recognition data. The second controller 220 may update the user characteristic data using the input data received in step S352.

In step S364 and S366, the second controller 220 of the first device 200-1 transmits the recognition data (namely, input data) stored in step S362 to the first terminal 100-1 and the second device 200-2 through the second communication interface 202.

In steps S3687 and S370, the first terminal 100-1 and the second device 200-2, store the recognition data. Each of the first terminal 100-1 and the second device 200-2 may update user characteristic data stored therein using the received recognition data.

Alternatively, the first device 200-1 may also transmit user characteristic data updated by using the input data, instead of the recognition data stored in step S362, to the first terminal 100-1 and the second device 200-2.

Further, although FIG. 6 illustrates the first device 200-1 transmitting the recognition data to the other apparatuses, namely, the first terminal 100-1 and the second device 200-2, the first terminal 100-1 and the second device 200-2 may also transmit recognition data or user characteristic data to other apparatuses to share the user characteristic data with the other apparatuses.

As described above, by sharing the user characteristic data, the first terminal 100-1, the first device 200-1, and the second device 200-2 may easily accumulate recognition data used to recognize the user. In this system, the more recognition data that is stored in the mobile communication terminal 100 and the device 200, the more accurately they can recognize a user. By sharing the user characteristic data, the mobile communication terminal 100 and the device 200 may quickly store a large amount of recognition data whenever they individually receive recognition data as input.

Also, the user characteristic data includes preference data. Accordingly, although the mobile communication terminal 100 and the device 200 may not receive, as input, various data representing a user's preference directly from the user, the mobile communication terminal 100 and the device 200 may still provide an optimized service to the user by using the shared preference data.

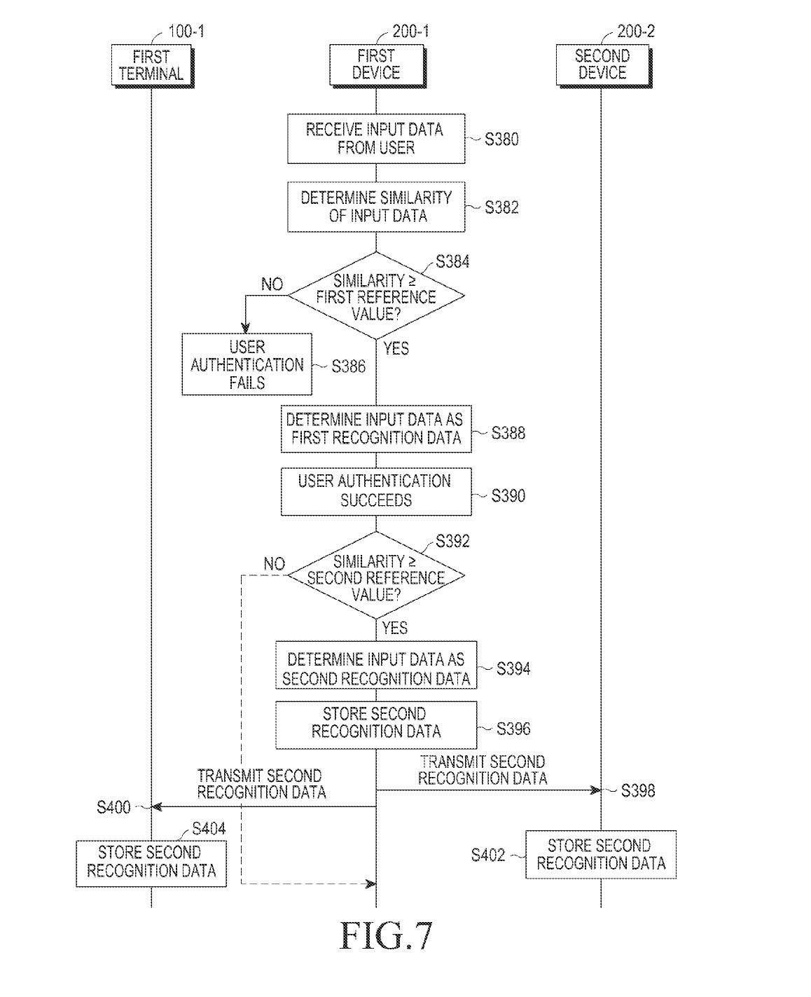

FIG. 7 is a signal flow diagram illustrating a method for sharing data in the data sharing system according to an embodiment of the present invention. In FIG. 7, the first terminal 100-1, the first device 200-1 and the second device 200-2 share identical user characteristic data.

Referring to FIG. 7, the operations performed in steps S380 to S396 are identical to those performed in steps S330 to S346 in FIG. 5. Accordingly, a repetitive description of steps S380 to S396 will not be provided herein.

In steps S398 and S400, the second controller 220 of the first device 200-1 transmits the second recognition data stored in step S396 to the first terminal 100-1 and the second device 200-2 through the second communication interface 202. The first terminal 100-1 and the second device 200-2, store the second recognition data in steps S402 and S404. Each of the first terminal 100-1 and the second device 200-2 may update user characteristic data stored therein using the received second recognition data.

Alternatively, the first device 200-1 may also transmit user characteristic data updated by using the input data, instead of the second recognition data stored in step S396, to the first terminal 100-1 and the second device 200-2.

Further, although FIG. 7 illustrates that the first device 200-1 transmits the second recognition data to the other apparatuses, namely, the first terminal 100-1 and the second device 200-2, the first terminal 100-1 and the second device 200-2 may also transmit recognition data or user characteristic data to other apparatuses, to share the user characteristic data with the other apparatuses.

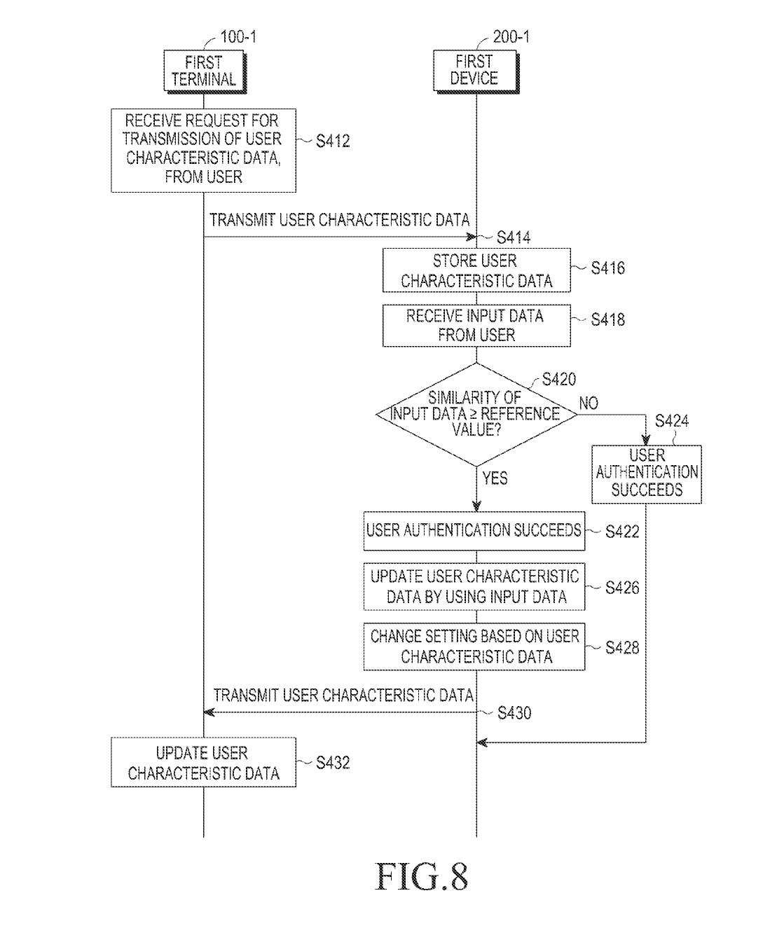

FIG. 8 is a signal flow diagram illustrating a method for sharing data in the data sharing system according to an embodiment of the present invention.

Referring to FIG. 8, in step S412, the first terminal 100-1 receives a request for transmission of user characteristic data, from a user. For example, the first terminal 100-1 may receive a request for transmitting user characteristic data, which has already been stored in the first memory 108, to the first device 200-1, from the user.

In step S414, the first terminal 100-1 transmits the user characteristic data to the first device 200-1 in a wired or wireless communication scheme.

In step S416, the first device 200-1 stores the user characteristic data received from the first terminal 100-1. In step S418, the first device 200-1 receives input data from the user. For example, the first device 200-1 may receive the input data through the second user recognizer 210. The first device 200-1 compares the input data with recognition data included in the user characteristic data received in step S414, in order to determine a similarity of the input data.

In step S420, the second controller 220 of the first device 200-1 determines whether the input data has a similarity that is greater than or equal to a reference value. When the input data has a similarity less than the reference value, the second controller determines that the user fails to be authenticated in step S424.

When the input data has a similarity greater than or equal to the reference value, the second controller 220 determines that the user is successfully authenticated in step S422.

In step S426, the first device 200-1 updates the user characteristic data by using the input data. Because the user has been successfully authenticated, the input data received from the user in step S418 may subsequently become at least some of recognition data used to recognize the user. Accordingly, the first device 200-1 may update the user characteristic data by using the input data received in step S418.

When the user characteristic data is updated, the second controller 220 changes a setting of the first device 200-1 based on updated user characteristic data in step S428. That is, the second controller 220 may change the setting of the first device 200-1 according to preference data included in the user characteristic data. For example, the second controller 220 may change a user interface of the first device 200-1. If the first device 200-1 is a TV, the second controller 220 may change a user interface of the TV based on the preference data, or may first display a favorite channel of the user on the TV.

In step S430, the second controller 220 transmits the updated user characteristic data to the first terminal 100-1. In step S432, the first terminal 100-1 updates the user characteristic data.

Alternatively, in step S420, the second controller 220 of the first device 200-1 may also determine whether the input data has a similarity that is greater than or equal to a first reference value. When the similarity is greater than or equal to the first reference value, the second controller 220 determines that the user is successfully authenticated. Also, the second controller 220 may determine whether the input data has a similarity that is greater than or equal to a second reference value, which is greater than the first reference value.

When the input data has a similarity that is greater than or equal to the second reference value, the second controller 220 may update the user characteristic data by using the input data. Namely, the second controller 220 may process the input data in such a manner as to apply different similarities when the user is intended to be authenticated and when the user characteristic data is intended to be updated.

According to another embodiment, the first controller 120 of the mobile communication terminal 100 may also process input data in such a manner as to apply different similarities when a user is intended to be authenticated and when user characteristic data is intended to be updated.

It will be appreciated that the method for sharing data according to the above-described embodiments of the present invention may be implemented in the form of hardware or a combination of hardware and software. Any such software may be stored in a volatile or non-volatile storage device such as a Read-Only Memory (ROM), or in a memory such as a Random Access Memory (RAM), a memory chip, a memory device or a memory integrated circuit, or in a storage medium, such as a Compact Disc (CD), a Digital Versatile Disc (DVD), a magnetic disk or a magnetic tape, which is optically or magnetically recordable and simultaneously, is readable by a machine (for example, computer), regardless of whether the software can be deleted or rewritten.

It will be appreciated that the method for sharing data according to the present invention may be implemented by using a computer or a portable terminal, which includes a controller and a memory, and that the memory is an example of a machine-readable storage medium suitable for storing a program or programs including instructions for implementing the exemplary embodiments of the present invention.

Accordingly, the present invention includes a program including a code for implementing an apparatus or a method claimed in any claim of this specification, and a storage medium, which is readable by a machine (computer or the like) and stores this program therein. Also, this program may be electronically conveyed via any medium such as a communication signal transmitted through a wired or wireless connection, and the present invention suitably includes equivalents of this program.

Also, the mobile communication terminal 100 or the device 200 may receive and store the program from an apparatus for providing a program, to which it is connected by a wire or wirelessly. The apparatus for providing a program may include: a memory for storing a program including instructions, which cause the mobile communication terminal 100 or the device 200 to perform a previously-set content protection method, information required for the content protection method, and the like; a communication unit for performing wired or wireless communication with the mobile communication terminal 100 or the device 200; and a controller for performing a control operation so as to transmit the relevant program to the apparatuses, automatically or at a request from the mobile communication terminal 100 or the device 200.

By the method for sharing data in the data sharing system, and the apparatuses for the same according to the present invention, the apparatuses can share user characteristic data, which is individually stored in the apparatuses in order to recognize a user, and thereby can more efficiently recognize the user.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents

What is claimed is:

1. A method for sharing data by a first terminal, the method comprising:
receiving a user input for transmitting user characteristic data to a second terminal;
discovering the second terminal to which the user characteristic data is to be transmitted; and
transmitting the user characteristic data to the second terminal.

2. The method of claim 1, further comprising:
receiving input data for authenticating a user, from the user;
comparing the input data with recognition data included in the user characteristic data;
determining a similarity between the input data and the recognition data;
determining whether the similarity is greater than or equal to a reference value; and
determining that the user is successfully authenticated, when the similarity is greater than or equal to the reference value.

3. The method of claim 2, further comprising updating the user characteristic data by using the input data.

4. The method of claim 3, further comprising transmitting the updated user characteristic data to the second terminal.

5. The method of claim 1, further comprising:
receiving input data for authenticating a user, from the user;
comparing the input data with recognition data included in the user characteristic data;
determining a similarity between the input data and the recognition data;
determining whether the similarity is greater than or equal to a first reference value;
determining that the user is successfully authenticated, when the similarity is greater than or equal to the first reference value;
determining whether the similarity is greater than or equal to a second reference value; and
updating the recognition data by using the input data, when the similarity is greater than or equal to the second reference value.

6. The method of claim 5, further comprising transmitting updated recognition data to the second terminal.

7. The method of claim 2, further comprising:
if the user is successfully authenticated, changing a user interface according to the user characteristic data; and
displaying the changed user interface.

8. A method for sharing data by a device, the method comprising:
receiving input data for authenticating a user, from the user;
comparing the input data with recognition data;
determining a similarity between the input data and the recognition data;
determining whether the similarity is greater than or equal to a first reference value; and
determining that the user is successfully authenticated, when the similarity is greater than or equal to the first reference value.

9. The method of claim 8, further comprising, before receiving the input data, receiving user characteristic data including the recognition data from another device.

10. The method of claim 9, further comprising updating the user characteristic data by using the input data.

11. The method of claim 8, further comprising:
determining whether the similarity is greater than or equal to a second reference value; and
updating the recognition data by using the input data, when the similarity is greater than or equal to the second reference value.

12. The method of claim 10, further comprising transmitting updated user characteristic data to another device.

13. The method of claim 9, further comprising:
if the user is successfully authenticated, changing a user interface according to the user characteristic data; and
displaying the changed user interface.

14. A mobile communication terminal comprising:
a user input unit configured to receive a user input for transmitting previously-stored user characteristic data to another terminal; and
a communication interface configured to:
discover the another terminal to which the user characteristic data is to be transmitted, and
transmit the user characteristic data to the another terminal.

15. The mobile communication terminal of claim 14, further comprising:
a user recognizer configured to:
if input data for authenticating a user is input through the user input unit; compare the input data with recognition data included in the user characteristic data, and
determine a similarity between the input data and the recognition data; and
a controller configured to:
determine whether the similarity is greater than or equal to a first reference value, and
determine that the user is successfully authenticated, when the similarity is greater than or equal to the first reference value.

16. The mobile communication terminal of claim 15, wherein the controller determines whether the similarity is greater than or equal to a second reference value, and updates the user characteristic data by using the input data, when the similarity is greater than or equal to the second reference value.

17. The mobile communication terminal of claim 16, further comprising a memory configured to store the updated user characteristic data.

18. The mobile communication terminal of claim 16, wherein the communication interface transmits the updated user characteristic data to another terminal.

19. The mobile communication terminal of claim 15, further comprising a display unit, wherein the controller changes a user interface according to the user characteristic data, if the user is successfully authenticated, and controls the display unit to display the changed user interface.

20. A device comprising:
a user input unit configured to receive input data for authenticating a user from the user; and
a controller configured to:
compare the input data with recognition data included in user characteristic data,
determine a similarity between the input data and the recognition data,
determine whether the similarity is greater than or equal to a first reference value, and
determine that the user is successfully authenticated, when the similarity is greater than or equal to the first reference value.

21. The device of claim 20, wherein the controller determines whether the similarity is greater than or equal to a second reference value, when the user is successfully authenticated, and updates the user characteristic data by using the input data, when the similarity is greater than or equal to the second reference value.

22. The device of claim 21, further comprising a communication interface configured to receive the user characteristic data from another terminal.

23. The device of claim 22, wherein the communication interface transmits the updated user characteristic data to the another terminal.

24. The device of claim 20, further comprising a display unit, wherein the controller changes a user interface according to the user characteristic data, if the user is successfully authenticated, and controls the display unit to display the changed user interface.
